(19) United States
(12) Patent Application Publication
(10) Pub. No.: US 2003/0039447 A1
(43) Pub. Date: Feb. 27, 2003

(54) Strip-loaded optical waveguide

(76) Inventor: Terry V. Clapp, Bishop's Stortford (GB)

Correspondence Address: Lee, Mann, Smith,, McWilliams, Sweeney & Ohlson, P.O. Box 2786, Chicago, IL, 60690-2786, US

(21) Appl. No.: 09/993,823

(22) Filed: Nov. 6, 2001

Related U.S. Application Data
(60) Provisional application No. 60/315,493, filed on Aug. 27, 2001.

(51) Int. Cl. G02B 6/26

(52) U.S. Cl. 385/40; 385/50; 385/43

(57) ABSTRACT

An optical waveguide device is described comprising an optical input, an optical output and a strip-loaded waveguide connected between the input and the output. The device further includes an additional material positioned adjacent a portion of the waveguide, the material having a higher refractive index than the waveguide such that an optical signal guided by the waveguide will at least partially couple into the material.

### TECHNICAL FIELD

The present invention relates to an optical waveguide, to methods of manufacturing and using such an optical waveguide, as well as devices incorporating such a waveguide. In particular, the present invention relates to strip-loaded waveguide architectures suitable for, but not limited to, incorporating an electro-optic element.

### BACKGROUND OF THE INVENTION

Electro-optic materials are materials that have optical properties that change in response to an electrical effect. Such materials, which include gallium arsenide (GaAs) and lithium niobate (LiNbO₃), are widely incorporated within devices for use in the telecommunications field, for the optical processing of optical signals. Such processing activities include, but are not limited to, optical signal switching, the modulation of optical signals, the demodulation of optical signals and the compensation of optical signals for dispersion effects that occur during the signal transmission.

Typically, such electro optic materials are incorporated within a ridge waveguide structure in which the ridge waveguide guides are designed to substantially contain the optical signal. The electro optic material can either be located within a slot within the ridge waveguide, or alternatively can be used to form the ridge waveguide. The ridge can be either freestanding or embedded within another material.

For instance, U.S. Pat. No. 5,410,625 describes an optical modulator formed from gallium arsenide. As can be seen schematically in FIG. 1, the modulator 10 comprises an input 12 and output 14 and a waveguide section 16. The waveguide section 16 is formed in a Mach-Zehnder configuration. Electrodes 18 are located adjacent one of the arms of the Mach-Zehnder interferometer.

An optical signal applied to the input 12 will be guided along the initial waveguide section 20, and then be split into two, substantially equal intensity, in phase signals at the splitter 22. An electric field applied across the arm 24a of the Mach-Zehnder interferometer will act to change the refractive index of the arm 24a i.e. it will change the velocity of any optical signal transmitted along that arm.

After transmission of the respective parts of the optical signal along the symmetrical mach-zehnder interferometer arms 24a and 24b, the two signals will be recombined at the recombining stage 26 and guided to the output 14.

By appropriate pulsing of the electric field applied by the electrodes, the optical signal transmitted along the arm 24a can be delayed (or sped up) in relation to the optical signal transmitted along arm 24b, so as to induce a relative phase change in the two signals. Consequently, it can be arranged for the two signals to interfere constructively or destructively at the recombiner 26. Thus by appropriate modulation of the electric field applied to the electrodes, a CW (continuous wave) optical signal applied to the input 12 can be modulated.

Research and development is continuously being performed to improve the performance of optical devices, particularly to accommodate the increasing optical transmission speeds. New materials are continuously being developed and tested.

Materials with superior electro optic properties to GaAs and LiNbO₃ do exist and have been tested within laboratories. However, incorporating such materials into practical optical devices which have a good manufacturing yield and are robust enough to cope with changes in temperature, vibrations and attack from environmental effects over time is a far from trivial matter. Typically, a completely new process and capabilities must be developed in respect of each material so as to accurately form the waveguide from the appropriate material.

Recently, several polymers have been shown to have extremely good optical and/or electro-optic characteristics. For instance, Akzo-Nobel Photonics (now part of the company JDS-Uniphase) have realised an optical switch using a proprietary polymer (the “Beam Box™” switch). The fully functional device has been made from the proprietary polymer, but at the compromise of the potential performance that would otherwise be achievable. Similarly, there are new start-up companies using polymer waveguide technology (for example Pacific Wave Industries) that have attempted to realise electro-optic waveguide devices with the active polymer performing the passive functions, and again considerable performance penalties have resulted from these approaches.

Such polymers, whilst having good electro-optic properties, tend to be relatively well ordered materials so as to maximise the dependence of the electro-optic effect to electric field, and hence tend to be relatively lossy (due to scattering and absorption). A typical polymer has a refractive index in the range of 1.5 to 1.6 i.e. much higher than that of optical fibre. Consequently, it is more difficult to optimally couple an optical fibre to a polymer-based wave-guide. Polymers also tend to have a high variation in refractive index with respect to temperature, are not particularly physically robust and can degrade over relatively long periods of time. This, in combination with the birefringence typically exhibited by polymers, often makes polymers unsuitable as waveguiding materials, even if such processing technology were developed that would allow a polymer waveguide to be produced.

It is an object of the present invention to provide a waveguide architecture that substantially addresses at least one of the problems of the prior art.

### SUMMARY OF THE INVENTION

In a first aspect the present invention provides an optical waveguide device comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material.

Hence, by using a strip loaded waveguide geometry that does not completely enclose the optical signal being transmitted along the waveguide, the optical signal can easily be coupled into the additional material located adjacent the waveguide. Such a design allows the optical properties of a variety of materials to be tested and/or used within an optical device. The additional material can be utilised in either a passive sense, or in an active sense i.e. an active sense is one in which the optical properties of the material are controllably changed over time. Unlike the prior art, very little processing technology for the additional material is required to implement such devices. Instead, it is possible to utilise a known technology to provide the majority of the waveguide structure, with the processing of the additional material being simplified so as to form simple structures adjacent the strip waveguide.

Preferably the additional material has optical properties that can be controllably altered. The properties of the optical signal passing through the device can hence be controlled, by controlling the optical properties of the material.

Preferably the material is an electro-optic material. Alternatively, any material could be utilised whose optical properties can be controllably altered. For instance, the material could be an acousto-optic material, in which the optical properties of the material are dependent upon the applied pressure, or even optically non-linear materials, in which the optical properties of the material change in dependence on the intensity of an applied optical signal.

For instance, the material can be a polymer. New polymers with good optical properties are continually being developed, but as described above often have poor waveguiding characteristics and/or undeveloped processing technologies. The present invention thus is particularly suitable for use with such materials, which would otherwise be difficult to implement into real devices.

Preferably the waveguide is formed from silica on silicon. Silica on silicon processing is well known and well understood. It is therefore eminently suitable for constructing the bulk of the optical waveguide device, upon which the additional material can be mounted. Additionally, such materials have a higher refractive index than optical fibre, but a lower refractive index than materials such as polymers. Consequently, optical signals from an optical fibre can be more easily coupled into a relatively high refractive index substance such as a polymer by utilising the silica on silicon material as an intermediate stage, rather than by directly attempting to couple the optical signal between the optical fibre and the polymer.

Further, processing technology for silica on silicon is well developed, and permits the accurate formation of relatively intricate structures, particularly structures that are relatively thin, such as a strip-loaded waveguide. Due to its very nature of enclosing the optical signal within the ridge, a ridge waveguide will naturally be thicker. This means that it is a strip-loaded waveguide that could be more accurately formed utilising silica on silicon processing technology (or an equivalent) than a corresponding ridge waveguide. As a strip loaded waveguide can be formed more precisely, then the waveguide geometry can be more easily formed into adiabatic structures that ensure the optical signal exhibits a smooth evolution of phase during transmission through the device, even if the signal is being split or recombined.

Preferably at least a portion of said material is adiabatically tapered such that at least one of the optical mode-field coupling from the existing waveguide to the material, or from the material back into the waveguide, is substantially adiabatic.

Preferably the device further comprises a cladding layer (to provide an optical cladding), the cladding layer being arranged to substantially overlay the additional material. Such a cladding material can be utilised to protect the additional material from environmental effects.

In another aspect the present invention provides an optical unit for the optical processing of an optical signal, the unit comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material, the unit further comprising control means arranged to alter the optical properties of said material.

Preferably the unit is arranged to perform the functions of at least one of a tuneable filter, a modulator, a demodulator, a switch, a polarisation mode dispersion compensator, or a chromatic dispersion compensator.

Preferably the waveguide is arranged as at least one of a Mach-Zehnder or a ring resonator or an arrayed waveguide grating. Such structures can be utilised either singly or in combination to realise a number of optical functions such as switching, modulation etc.

Preferably the optical unit comprises two of said optical waveguide devices, the unit further comprising splitter means arranged to split an optical signal input to said unit so as to send a portion of the input signal to a respective input of each waveguide device, the splitting means being arranged such that the signals received at the respective optical waveguides have an electrical field parallel to the respective strip waveguides. Strip loaded waveguides may be designed to optimally guide optical signals which have an electric field parallel to the plane of the respective strip forming the waveguide. A device which splits the polarisation modes of the optical signal, and ensures that each part of the signal is transmitted along a strip loaded waveguide in the preferred optical configuration with the electric field parallel to the strip waveguide, will ensure that the optical signal is transmitted more effectively than an optical signal which has electric field components not so aligned.

For instance, the splitting means can comprise a walk-off plate and a half waveplate.

Preferably the unit further comprises a light source arranged to provide an optical input to said device. For instance, such a light source could include a laser, or even a laser with various control means, such as a modulator and/or variable optical attenuator.

In another aspect the present invention provides a node in a communications network comprising a receiver for receiving a signal, a transmitter for the onward transmission of a signal, at least one of the received signal and the transmitted signal being an optical signal, and an optical waveguide device comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material.

In a further aspect the present invention provides a method of using an optical waveguide device, the optical waveguide device comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material, the method comprising the steps of providing an optical signal to the input of said device; the signal being transmitted along said optical waveguide, and coupling in and out of said additional material; and the optical signal being output at the device output.

In a final aspect the present invention provides a method of manufacturing an optical waveguide device, the method comprising the steps of: forming an optical input for receiving an optical signal; forming an optical output for the output of an optical signal; forming an optical waveguide comprising a strip-loaded waveguide connected between said input and said output; and positioning a material adjacent at least a portion of said waveguide such that an optical signal transmitted along the waveguide will couple in and out of said additional material.

### BRIEF DESCRIPTION OF THE DRAWINGS

In order to show how the invention may be carried into effect, embodiments of the invention will now be described by way of example only and with reference to the accompanying figures in which:

FIG. 1 shows a sketch of a ridge waveguide in a Mach-Zehnder configuration (PRIOR ART);

FIG. 2 shows a 3-d sectional view of a strip-loaded waveguide rendition of a Mach-Zehnder configuration in accordance with the present invention;

FIGS. 3a and 3b show alternative non-sectional views of how the strip-loaded waveguide of FIG. 2 can be embedded within, or mounted upon the glass core layer;

FIG. 4 shows an embedded ridge waveguide (PRIOR ART);

FIG. 5 shows a cross-section of the strip-loaded waveguide of FIG. 2 sectioned through the arm of the device incorporating the polymer;

FIG. 6 shows a schematic diagram of how the present invention can be utilised to provide the same functionality as the prior art device of FIG. 1;

FIG. 7 shows how the present invention can be utilised to change the optical path length of a ring resonator;

FIG. 8a shows how the present invention can be utilised to switch on or off the coupling of an optical signal into a ring resonator;

FIG. 8b shows how the present invention can be utilised to switch an optical signal between two waveguides; and

FIG. 9 shows how the present invention can be arranged to transmit an optical signal such that it always has an electric field parallel to the strip waveguide, by utilising two Mach-Zehnder configurations (as shown in FIG. 6) in parallel.

### DESCRIPTION OF PREFERRED EMBODIMENTS

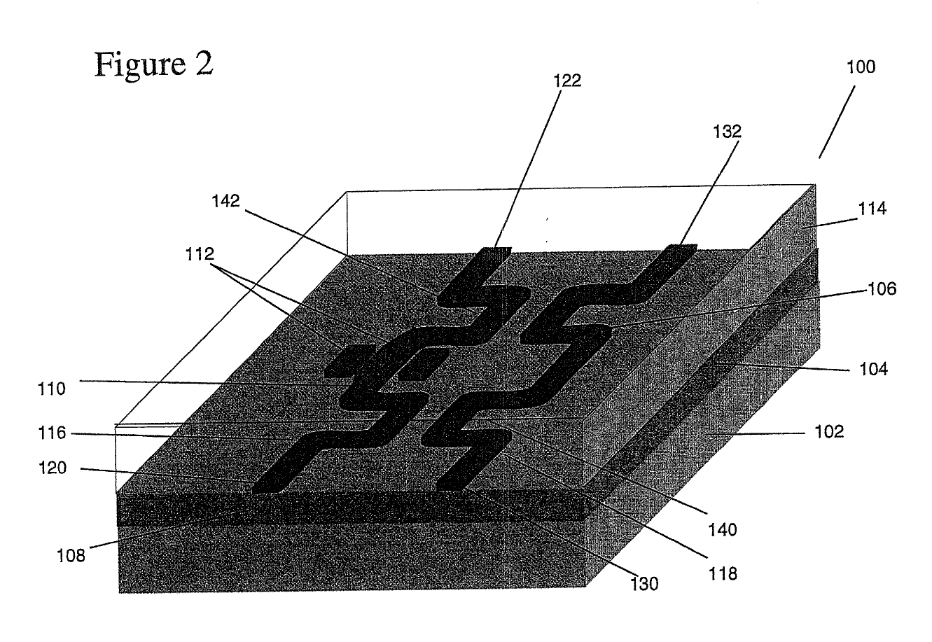

FIG. 2 shows a three-dimensional sketch of an optical device 100 utilising a strip loaded slab waveguide geometry configured as a Mach-Zehnder. The device comprises a waveguide buffer layer (or lower cladding layer) 102 formed from a compound glass wafer selected to have preferred thermo-physical property/parameter sets. The criterion chosen would be based upon a suitable refractive index, a thermal coefficient of expansion well matched to the upper layers, as well as glass transition temperatures and viscosity temperature characteristic appropriate to the wave-guide device processing. As shown in the figure, a glass core layer 104 overlays the buffer layer 102, and formed upon the core layer 104 is a strip-loaded waveguide 106 shaped in a Mach-Zehnder configuration.

An electro-optic polymer 110 is formed upon a portion of the strip loaded waveguide 106, with electrodes located adjacent the polymer so as to enable the optical properties of the polymer to be controlled. Overlaying the strip loaded waveguide 106, the polymer 110 and the electrodes 112 is a further cladding layer 114 arranged to protect the upper surface of the structure from environmental effects. Such a cladding layer 114 can be formed of a polymer of lower refractive index than that of the strip-loaded wave-guide 106 and of the wave-guide core layer 104.

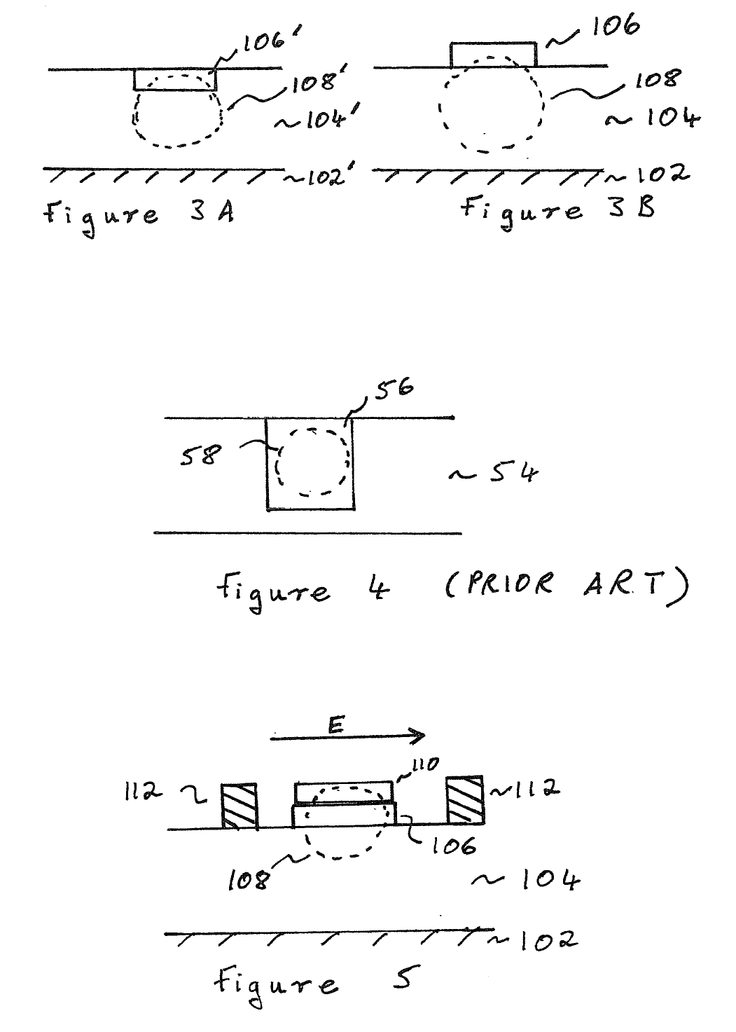

FIGS. 3a and 3b show cross-sections of alternative configurations of one arm of the Mach-Zehnder wave-guide shown in FIG. 2. FIG. 3a shows a core layer 104′ formed on top of a buffer layer 102′, with a strip waveguide 106′ embedded within the upper surface of the core layer 104′. FIG. 3b shows the core layer 104 again formed upon the buffer layer 102, but has the strip waveguide 106 formed upon the surface of the core layer 104, rather than embedded within it.

In both FIG. 3a and 3b, the dotted outline of the guided mode of the optical signal (108′, 108) is illustrated; the optical signal can be envisaged as propagating into the page. The optical signal is confined at a lower boundary by the buffer layer 102′, which is designed to give an appropriate level of mode confinement. The core layer 104′, 104 comprises a slab of material designed to be capable of sustaining a guided mode of the optical signal at the desired wavelength. The strip loaded waveguide 106′, 106 is of higher refractive index than that of the core layer 104′, 104, and arranged to be of sufficient thickness that it provides enough lateral confinement to define a channel waveguide.

Strip waveguide configurations are known in the prior art, and have historically been utilised in microwave transmission systems. Due to the relatively poor lateral confinement characteristics of strip-loaded waveguides, current optical devices normally use a ridge waveguide structure, as is shown in cross section in FIG. 4. The ridge waveguide typically comprises a buffer layer 54 and a core layer 56 of higher refractive index embedded within the buffer layer. Such a waveguide is arranged to substantially encapsulate the guided optical signal 58 within the guiding core layer 56.

In the preferred embodiment, the strip loaded waveguide configuration of FIG. 3b is utilised, in which the strip waveguide 106 is formed on the surface of the core layer 104. This configuration is preferred as it allows the easy formation of the waveguide structure 106. A loading layer of the desired waveguide material can be formed upon the core layer 104, the loading layer being of sufficient thickness that when patterned it provides sufficient lateral confinement to define the “channel” waveguide 106. This structure then provides a basis for a device to be realised that can guide light adequately and can realise a variety of device layouts. It has a significant advantage in that thin film patterning can be achieved with very high accuracy with little line width reduction (during RIE, reactive ion etching) and good capabilities to enable a near net shape transfer from the mask.

In the preferred embodiment shown in FIG. 2, the buffer layer 102 can be formed from a suitable substrate such as a silica wafer, but is preferably formed from a compound glass wafer such as a silicate doped with one or more of boron, fluorine, germanium, phosphorous and aluminium. In the latter case, the substrate might preferably be a silicon wafer processed using known techniques typically employed in planer waveguide fabrication processes for example, PECVD (Plasma Enhanced Chemical Vapour Deposition).

Such a buffer layer 102 is designed to give an appropriate level of mode-field isolation. Typical dimensions for achieving this would be a 15 micrometers thickness of silica on silicon. The core layer 104 is arranged to be capable of sustaining a guided mode of the optical signal at the desired wavelength. It would typically be between 4-7 micrometers thick and be composed of doped silica. The refractive index will be larger than that of the buffer, (assuming the buffer to be silica) typically having a refractive index of 5×10⁻³ to 20×10⁻³ greater than silica at a wavelength at 1523 nanometers (at 20° C., silica has a refractive index of 1.4463 at 1523 nanometers wavelength). Such a layer would normally remain substantially unpatterned. The strip waveguide 106 is formed of a material of substantially higher refractive index, such as silicon nitride. A typical strip waveguide formed of silicon nitride would be around 4-7 micrometers wide and around 300-700 nanometers thick.

As shown in FIG. 2, the polymer 110 is located upon a length of the strip waveguide 106, with metal strip lines or electrode structures 112 formed adjacent upon 110, for provision of electric fields suitable for controlling the optical properties of the polymer. The polymer could be deposited on the strip waveguide 106 by the process of spinning, or by direct printing techniques, such as inkjet printing or imprint lithography; or other processes, appropriate to the device requirements. The polymer need only be of sufficient length (in the direction of propagation of the optical signal) to achieve the desired optical functionality, in this case that of providing a phase shift modulation to a propagating optical signal. As shown in FIG. 2, the polymer 110 can be laterally tapered so as to effect the adiabatic transfer of optical power, both from the slab guided mode into the rib guided mode achieved while propagating along the length of the polymer, and back again into the slab guided mode.

FIG. 5 shows a cross section of the device of FIG. 2 along a portion of the strip loaded waveguide upon which the polymer 110 is mounted. The structure is generally similar to that shown in FIG. 3b, with the addition that a section of the polymer 110 lays (in the orientation illustrated) on top of the strip waveguide section 106. Further, the electrodes 112 are located upon the surface of the core layer 104, laterally either side of the polymer 110. Due to the polymer layer 110 having a higher refractive index than the slab waveguide 104, the optical signal 108 has moved up into the polymer layer 110 to an extent governed by the local normal mode set by the compound waveguide structure, as defined by the index and the thickness of the polymer overlay. The electrodes 112, by being disposed either side of the polymer 110 can act to provide an electric field through the polymer and substantially parallel to the plane of the waveguide 106 e.g. in the direction shown by “E” in FIG. 5. The strip-loaded waveguide geometry most optimally guides an optical signal in which the electric field is also parallel to the plane of the waveguide (e.g. also in the direction shown by the letter “E” in FIG. 5). It will thus be appreciated that the change in optical properties brought about by the electric field provided by the electrodes 112 will have the maximum effect upon the polarization mode most optimally guided by the strip waveguide. Further more the guidance properties can be set to optimally confine the mode and permit a close juxtaposition of waveguide and electrode.

Various configurations of waveguide may be formed in accordance with the present invention For instance, FIG. 2 shows a two-armed Mach-Zehnder interferometer configuration, in which the strip-loaded waveguide 106 is formed into two symmetrical arms 116, 118. Although the inputs and outputs of such a device are by its very nature interchangeable, the operation will now be described assuming that light will only propagate from left to right within the figure shown. An optical signal 108 can be input to either of the inputs of the arms 120, 130. If an optical signal is input into arm 116, then it will propagate along the arm to the first coupling region 140. At this first coupling region, due to the proximity of the two arms 116, 118, a portion of the optical signal 118 will couple from the first arm 116 to 118. The portion of the signal coupled from the first arm 116 to the second arm 118 will depend upon the spacing of the two arms in the coupling region, as well as the length of the coupling region. Normally this geometry is chosen such that one half of the signal will couple from one arm to the other. Both portions of the optical signal will continue to propagate along the respective arms 116, 118 towards the respective outputs 122, 132. The portion of the optical signal in arm 116 will be coupled into the polymer 110. As the polymer is an electro-optic material, the refractive index of the material (and hence the velocity of the optical signal propagating through the polymer) can be controlled by varying the electric field between the electrodes 112.

The optical signals appearing in the waveguide arms 116, 118 at the second coupling region 142 will then interfere constructively or destructively in this region depending upon the relative phase change that has been applied to the optical signal portion by the polymer 110. This phase change will govern the coupling of the optical signal that occurs within the region 142, and hence the portion of each signal that will appear at the respective output 122, 132 of each arm.

The current invention thus circumvents the problems of the prior art, and permits the advantageous optical and electro-optic properties of polymers to be employed in combination with the preferred properties of inorganic glassy materials and in extension of the ‘silica-on-silicon’ manufacturing platform.

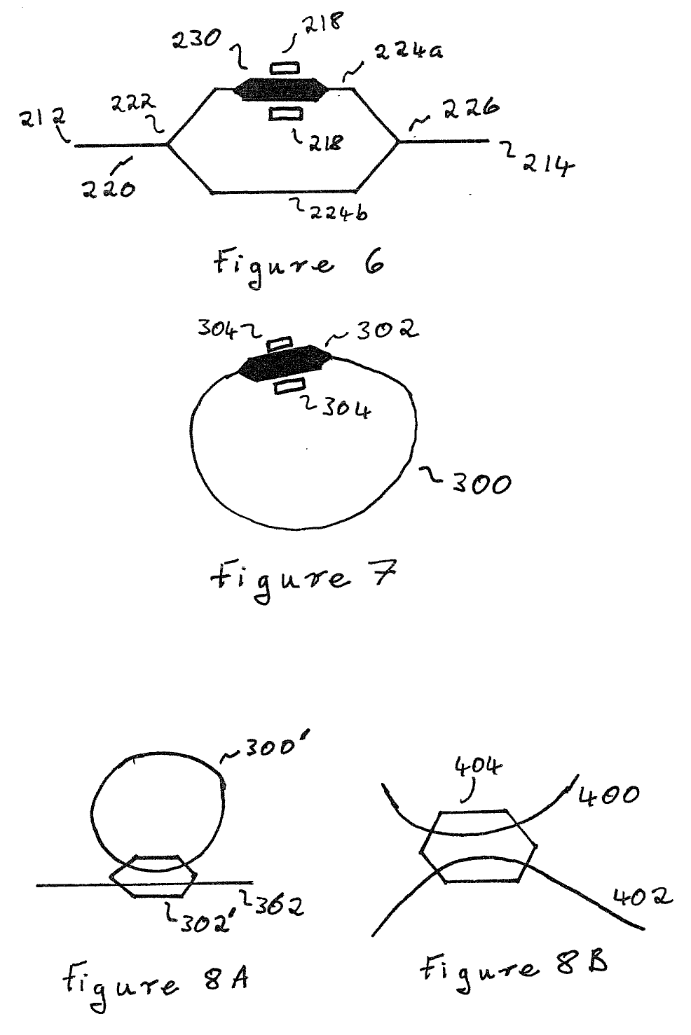

By way of example only, FIGS. 6 to 9 show plan views of alternative configurations of-the strip waveguides.

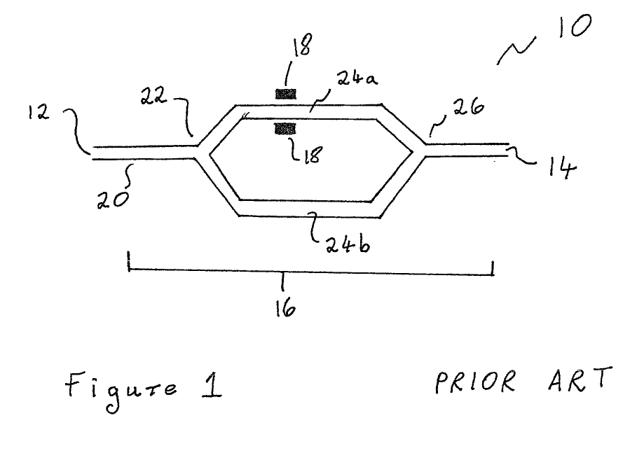

FIG. 6 shows a Mach-Zehnder configuration similar to that shown in FIG. 1 but implemented using a strip waveguide. An optical signal applied to the input 212 will propagate along the initial waveguide section 220 to the splitter 222, where upon it will be split into two substantially equal portions. Each portion will propagate along the respective waveguide arm 224a to 224b to the recombiner 226, where upon the signals will be recombined and guided to the output 214. Electrodes 218 are utilised to control the electro-optic properties of the polymer 230 which overlays a portion of the waveguide 224a. As can be seen, the ends of the polymer 230 are laterally tapered so as to achieve adiabatic transitions between the polymer 230 and the strip waveguide section 224a. This architecture can thus be used to provide the same functionality as that shown in FIG. 1.

FIG. 7 shows a strip waveguide formed in the shape of a ring 300, with a polymer 302 overlying a section of the waveguide 300. The electro-optic properties of the polymer can be controlled via the electrodes 304. By changing the refractive index of the polymer 302, it will be appreciated that the effective optical path length of the ring can be altered i.e. the structure serves to provide an optical ring resonator of varying path length.

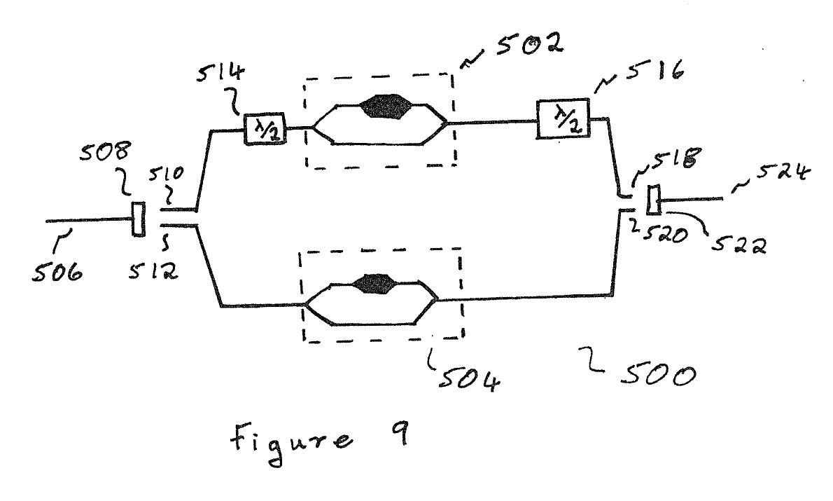

It will be appreciated by the skilled person that a number of functions can be provided by utilising various combinations of linear waveguides, Mach-Zehnder and ring resonators. For instance, FIG. 8a shows a linear strip waveguide 362 located adjacent a strip waveguide formed into the shape of a circle 300′ (i.e. a ring resonator). The strip waveguide 362 is located sufficiently close to the ring resonator 300′, so as to allow the coupling of signals between the two waveguides. An electro-optic polymer 302′ overlies this coupling region, and can thus be utilised to control the coupling of any optical signal propagating along the waveguide 362 into and out of the ring resonator 300′.

FIG. 8b shows a potential switch architecture, in which two separate waveguides 400, 402 pass sufficiently close to each other such that an optical signal can couple from one waveguide to the other. An electro-optic polymer 404 overlies this coupling region, and can be used to control switching of a signal from one waveguide 400 to the other 402 (or vice versa) by changing the effective pathlength of the coupling region.

FIG. 9 shows an optical unit 500 including two identical Mach-Zehnder devices 502, 504 (as illustrated in detail in FIG. 6). It will be appreciated that optical signals can propagate in a number of polarisation modes (e.g. left or right circularly polarised, or linearly polarised), but that all such polarisation modes can be split up into two orthogonal linearly polarised modes. The strip loaded waveguide architecture optimally guides an optical signal in which the electric field is substantially parallel to the plane of the strip. The architecture of this unit 500 is arranged to ensure that the full optical signal is optimally propagated along the strip waveguides sections 502, 504. The ridge waveguide architecture (or other suitable wave-guiding structure e.g. optical fibre) can be utilised to provide the appropriate inputs to these Mach-Zehnder sections 502, 504.

An optical signal provided at input 506 will propagate along the waveguide to the walk-off plate 508. Such a plate can consist of a rutile material, and is for instance, described in U.S. Pat. No. 6,014,475. The walk-off plate acts to split apart the polarisation modes of an optical signal into two linear orthogonal polarisation modes. The architecture is arranged such that a first polarisation mode (that corresponding to an electric field parallel to the strip waveguide of Mach-Zehnder 504) is applied to the optical waveguide input 512, whilst the orthogonal linear component is applied to waveguide input 510. This orthogonal component passes through a half waveplate 514, arranged so as to result in the orthogonal component hence being reorientated such that it now has an electric field parallel to the strip waveguide structure of Mach-Zehnder 502.

After each respective polarisation mode has been modulated (or otherwise processed) by the respective Mach-Zehnder units 502, 504, the signals propagate to outputs 518, 520. The signal that has passed through Mach-Zehnder 502 will pass through another halfwave plate 516 prior to the output 518, so as to return the polarisation mode to its original sense i.e. that orthogonal to the signal at output 520. By providing the outputs 518, 520 to the appropriate positions on a rutile plate 522, the orthogonal linear polarisation modes can be returned to a single signal that has been processed as desired by Mach-Zehnders 502, 504. Such units 502, 504 will be substantially identical, and whilst in this embodiment they have been described as Mach-Zehnder structures, it will be appreciated that they could be replaced by any other desired waveguide configuration to achieve an appropriate function. Similarly it is sometimes desirable to utilise a device in a reflective mode, in such cases the signal on each path would retrace its passage through the device emerging via the wave-plate and walk-off element as appropriate. In these cases the launched signal will most probably have been sourced via an optical circulator.

Whilst the present invention has been described with respect to efectro-optic polymers, it will be appreciated that the invention allows the utilisation of any material in which the optical properties can be controlled, whether by an electric signal or otherwise.

In the above the term polymer is used as a generalised description, in the context of this invention the material may be polymeric, dendritic, oligomeric or one of the supramolecular systems such as liquid crystals and or other appropriate electro-optic or non-linear optical materials. Similarly, whilst the preferred embodiments are directed towards the use of this geometry and principle to extend the silica-on-silicon manufacturing platform, advantageously, however, other materials systems including optical quality glasses and/or polymers could substitute and fall within the scope of the present invention.

The invention allows a simple waveguide device to be realised with a format eminently suitable for rapid prototyping. Also the device topology is particularly suitable to incorporate active functionings realised in soft materials (for which mature process routes to waveguide devices are not yet available),.which enable active functions for waveguide devices for which a real market opportunity exists, but where the materials immaturity is preventing deployment. Further, this invention allows the partitioning of the waveguide device into block functional elements whereby materials with desired optical properties need only be employed to realise their active function, and do not have to additionally perform the passive waveguide functions for which they are not readily suited. The invention thus provides a manufacturable device topology with a cost performance advantage over conventional waveguide designs.

1. An optical waveguide device comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material.

2. A device as claimed in claim 1, wherein said additional material has optical properties that can be controllably altered.

3. A device as claimed in claim 1, wherein said material is an electro-optic material.

4. A device as claimed in claim 1, wherein said material is selected from the group consisting of a polymer or other oligomer, dendrimer, liquid crystal or supramolecular system.

5. A device as claimed in claim 1, wherein said waveguide is formed from silica on silicon.

6. A device as claimed in claim 1, wherein at least a portion of said material is adiabatically tapered such that at least one of the optical-signal coupling from the wave-guide to the material, or from the material to the wave-guide, is substantially adiabatic.

7. A device as claimed in claim 1, further comprising a cladding layer, said cladding layer being arranged to substantially overlay the additional material.

8. An optical unit for the optical processing of an optical signal, the unit comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material, the unit further comprising control means arranged to alter the optical properties of said material.

9. A unit as claimed in claim 8, the unit being arranged to perform the functions of at least one of a tuneable filter, a modulator, a demodulator, a switch, a polarisation mode dispersion compensator or a chromatic dispersion compensator.

10. An optical unit as claimed in claim 8, wherein said waveguide is arranged as at least one of a Mach-Zehnder, a ring resonator, or an arrayed waveguide grating.

11. An optical unit as claimed in claim 8, the unit comprising two of said optical waveguide devices, the unit further comprising splitter means arranged to split an optical signal input to said unit so as to send a portion of the input signal to a respective input of each waveguide device, the splitting means being arranged such that the signals received at the respective optical waveguides have an electrical field parallel to the respective strip waveguides.

12. A unit as claimed in claim 11 wherein said splitting means comprises a walk-off plate and a half waveplate.

13. A unit as claimed in claim 8, the unit further comprising a light source arranged to provide an optical input to said device.

14. A node in an communications network comprising a receiver for receiving a signal, a transmitter for the onward transmission of a signal, at least one of the received signal and the transmitted signal being an optical signal, and
an optical waveguide device comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material.

15. A communications system comprising a plurality of the nodes as claimed in claim 14.

16. A method of using an optical waveguide device, the optical waveguide device comprising at least one optical input for receiving an optical signal; at least one optical output for the output of an optical signal; and an optical waveguide connected between said input and said output; wherein said optical waveguide comprises a strip loaded waveguide, and the device further comprises an additional material positioned adjacent at least a portion of the waveguide, the material having a higher refractive index than the waveguide such that an optical signal guided by the waveguide will at least partially couple into the material, the method comprising the steps of:
providing an optical signal to the input of said device;
the signal being transmitted along said optical waveguide, and coupling in and out of said additional material; and
the optical signal being output at the device output.

17. A method of manufacturing an optical waveguide device, the method comprising the steps of:
forming an optical input for receiving an optical signal;
forming an optical output for the output of an optical signal;
forming an optical waveguide comprising a strip-loaded waveguide connected between said input and said output; and
positioning a material adjacent at least a portion of said waveguide such that an optical signal transmitted along the waveguide will couple in and out of said additional material.
